(19) United States
(12) Patent Application Publication
(10) Pub. No.: US 2026/0120571 A1
(43) Pub. Date: Apr. 30, 2026

(54) VEHICLE ACCIDENT DETECTION AND AUTOMATIC REPORTING SYSTEM CAPABLE OF ANALYZING ACCIDENT TYPE AND SEVERITY

(71) Applicant: MYREN INC., Yeongcheon-si (KR)

(72) Inventor: Eun Hong CHOI, Gwangmyeong-si (KR)

(73) Assignee: MYREN INC., Yeongcheon-si (KR)

(21) Appl. No.: 18/958,207

(22) Filed: Nov. 25, 2024

(30) Foreign Application Priority Data
Oct. 28, 2024 (KR) 10-2024-0148745

(51) Int. Cl. G08G 1/16; B60Q 9/00

(52) U.S. Cl. CPC G08G 1/165; B60Q 9/008

(57) ABSTRACT

A vehicle accident detection and automatic reporting system is disclosed. A vehicle accident detection and automatic reporting system includes a vehicle terminal which is mounted in a vehicle and acquires driving information of the vehicle and a user terminal owned by a user who rides in the vehicle, and the user terminal includes a sensor module which detects movement information of the vehicle, a communication unit which communicates with the vehicle terminal and receives the vehicle driving information, and a control unit which determines whether an accident of the vehicle occurs using the vehicle driving information and the vehicle movement information.

### CROSS-REFERENCE TO RELATED APPLICATIONS

This application claims priority to and the benefit of Korean Patent Application No. 10-2024-0148745 filed in the Korean Intellectual Property Office on Oct. 28, 2024, the entire contents of which are incorporated herein by reference.

### BACKGROUND

### Field

The present disclosure relates to a vehicle accident detection and automatic reporting system, and more particularly, to a vehicle accident detection and automatic reporting system which uses an AI deep learning algorithm to analyze an accident type and an accident severity, automatically generate an accident report, and transmit the generated accident report to an emergency rescue organization.

### Description of the Related Art

In the related art, there was a method in which a driver directly contacted a rescue team or police or someone else, such as the other driver or a witness, reported the accident situation to the rescue team or police to deal with a traffic accident.

When the driver directly contacted emergency contact such as the rescue team or police, or insurance companies, various actions were required according to traffic accident safety rules, which sometimes resulted in delay in reporting the accident.

In particular, in situations where there are few people, such as late at night or early in the morning, or on remote roads, when a car accident occurs and the driver and passengers lose consciousness, there are few witnesses, so reporting is delayed, and this often leads to fatal accidents. Therefore, in such a situation where there are no witnesses to a car accident and the driver and passengers cannot report it themselves, a real-time emergency rescue system platform that can automatically report it is required.

### SUMMARY

An object of the present disclosure is to provide a vehicle accident detection and automatic reporting system which when a vehicle accident occurs, notifies the occurrence of the accident from a user terminal to a vehicle accident notification server and allows the vehicle accident notification server to notify the accident occurrence to an accident response organization, to quickly respond the accident.

Further, an object of the present disclosure is to provide a vehicle accident detection and automatic reporting system which automatically notifies a vehicle accident notification server of the occurrence of the accident when an accident occurs and a predetermined transmission standby state maintaining time elapses in a data transmission standby state to respond the accident.

An object of the present disclosure is to provide a vehicle accident detection and automatic reporting system which automatically generates a vehicle accident report when a vehicle accident occurs and transmits the generated accident report to the emergency rescue organization.

An object of the present disclosure is to provide a vehicle accident detection and automatic reporting system which uses a previously trained AI deep learning algorithm to extract a feature point pre-vehicle collision data and post-vehicle collision data based on an collision time and determine an accident type and severity by comparing the feature point with a previously ensured feature point of an accident type and severity.

According to an aspect of the present disclosure, a vehicle accident detection and automatic reporting system includes a vehicle terminal which is mounted in a vehicle and acquires driving information of the vehicle; and a user terminal owned by a user who rides in the vehicle, the user terminal includes: a sensor module which detects movement information of the vehicle; a communication unit which communicates with the vehicle terminal and receives the vehicle driving information; and a control unit which determines whether an accident of the vehicle occurs using the vehicle driving information and the vehicle movement information.

Further, the control unit includes a report generation unit which when it is determined that the accident of the vehicle occurs, generates an accident report using the vehicle driving information and the vehicle movement information.

The accident report includes driver information, vehicle identification information, accident type information, accident occurrence location information, vehicle accident time information, weather information, body movement information, and satellite photograph information of the accident occurrence point.

The vehicle movement information includes yaw, roll, and acceleration information of a vehicle body.

The vehicle accident detection and automatic reporting system further includes a vehicle accident notification server which receives the accident report from the communication unit and transmits the accident report to an accident response organization.

When it is determined that the vehicle accident occurs, the control unit displays an accident occurrence confirmation message on a display of the user terminal for a predetermined time and the report generation unit generates the accident report at the time when the user checks the accident occurrence confirmation message or the predetermined time elapses.

According to another aspect of the present disclosure, a vehicle accident detection and automatic reporting system includes a vehicle terminal which is connected to an OBD connector mounted in a vehicle; and a user terminal which is communicable with the vehicle terminal and is owned by a user who rides in the vehicle, the vehicle terminal includes: a driving information collection unit which collects the vehicle driving data from the OBD connector; an inertia measurement sensor which measures acceleration data of the vehicle terminal; a processor which determines vehicle collision, calculates a collision time, and extracts pre-vehicle collision data obtained for a predetermined time before the collision time and post-vehicle collision data obtained for a predetermined time after the collision time, using acceleration data measured by the inertia measurement sensor; and a communication module which is communicable with the vehicle terminal and transmits the pre-vehicle collision data and the post-vehicle collision data to the user terminal.

The vehicle terminal further includes: a GPS module which receives location data of the vehicle terminal and the communication module transmits the location data at the collision time to the user terminal.

The vehicle terminal includes: an accident judgment unit which trains an AI deep learning algorithm with pre-vehicle collision data and post-vehicle collision data as input data and compares the learning result with previously stored accident pattern information to determine whether accident occurs; an accident type and severity analysis unit which uses a previously trained AI deep learning algorithm to divide the pre-vehicle collision data and the post-vehicle collision data by a predetermined time interval based on the collision time to generate a plurality of segments and the segments are compressed to have different sizes to generate a segment compression signal, extract a feature point from each segment compression signal, and compare the feature point with a feature point of the previously accident type and severity to determine the accident type and severity.

Further, the accident type and severity analysis unit divides the segments such that the closer to the collision time, the shorter the time length of the segments generated from the pre-vehicle collision data and the post-vehicle collision data and the further from the collision time, the longer the time length of the segments generated from the pre-vehicle collision data and the post-vehicle collision data at the collision time.

The segment compression signal includes a driving speed segment compression signal and an acceleration segment compression signal and when a difference between the feature point extracted from the driving speed segment compression signal and the feature point extracted from the acceleration segment compression signal exceeds a threshold value, the accident type and severity analysis unit determines as minor collision or collision with a soft object.

Further, the vehicle terminal further includes a microphone which receives surrounding sound signals in the vehicle and the pre-vehicle collision data includes surrounding sound data received by the microphone during a predetermined time before the collision time and the post-vehicle collision data includes surrounding sound data received by the microphone during a predetermined time after the collision time.

According to the present disclosure, when a vehicle accident occurs, a user terminal notifies a vehicle accident notification server of an accident occurrence and a vehicle accident notification server notifies an accident response organization of the accident occurrence again to enable quick accident response.

Further, according to the present disclosure, when the accident occurs and a transmission standby state maintaining time which is set in advance as a data transmission standby state elapses, the accident occurrence is automatically notified to the vehicle accident notification server to enable quick accident response.

Further, according to the present disclosure, when the vehicle accident occurs, an accident occurrence report is automatically generated and the generated accident occurrence report is transmitted to the emergency rescue organization so that the emergency rescue organization may quickly identify a vehicle accident type, a vehicle accident occurrence location, accident vehicle information, and driver information.

Further, according to the present disclosure, a previously trained AI deep learning algorithm is used to divide pre-vehicle collision data and post-vehicle collision data by a predetermined time interval based on the collision time to generate a plurality of segments and compress the segments to have different sizes to generate a segment compression signal, extract a feature point from each segment compression signal, and compare the feature point with a previously ensured feature point of the accident type and severity to determine the accident type and severity.

### BRIEF DESCRIPTION OF THE DRAWINGS

FIG. 1 is a view illustrating a vehicle accident detection and automatic reporting system according to an exemplary embodiment of the present disclosure;

FIG. 2 is a view illustrating a detailed configuration of a user terminal of FIG. 1;

FIG. 3 is a view illustrating a detailed configuration of a control unit according to an exemplary embodiment of the present disclosure;

FIG. 4 is a view illustrating information included in an accident report according to an exemplary embodiment of the present disclosure;

FIG. 5 is a view illustrating a vehicle accident notification server according to an exemplary embodiment of the present disclosure;

FIG. 6 is a view illustrating a detailed configuration of a central processing unit according to an exemplary embodiment of the present disclosure;

FIG. 7 is a view illustrating a detailed configuration of a vehicle terminal according to another exemplary embodiment of the present disclosure;

FIG. 8 is a view illustrating a detailed configuration of a terminal sensor module of FIG. 7;

FIG. 9 is a view illustrating a detailed configuration of a user terminal according to another exemplary embodiment of the present disclosure;

FIG. 10 is a view illustrating a detailed configuration of a control unit according to an exemplary embodiment of the present disclosure of FIG. 9;

FIG. 11 is a view illustrating that pre-vehicle collision data and post-vehicle collision data are divided into a plurality of segments with respect to a collision time according to an exemplary embodiment of the present disclosure; and

FIG. 12 is a flowchart illustrating a method of detecting and automatically reporting a vehicle accident using a vehicle terminal and a user terminal according to an exemplary embodiment of FIGS. 7 to 11.

### DETAILED DESCRIPTION OF THE EMBODIMENT

Hereinafter, exemplary embodiments of the present disclosure will be described in detail with reference to the accompanying drawings. However, the technical spirit of the present disclosure may be specified in different ways without being limited to the exemplary embodiment to be described herein. On the contrary, exemplary embodiments introduced herein are provided to make disclosed contents thorough and complete and sufficiently transfer the spirit of the present disclosure to those skilled in the art.

In the present specification, when it is mentioned that any component is disposed on another component, it means that the component may be formed directly on another component or a third component may be interposed therebetween. Further, in the drawings, thicknesses of films and regions may be exaggerated for effective description of the technical contents.

Although terms such as first, second, third, etc. have been used in various embodiments of this specification to describe various components, these components should not be limited by these terms. These terms are just used to distinguish any component from another component. Accordingly, a component which is mentioned as a first component in any one exemplary embodiment may be mentioned as a second component in another exemplary embodiment. Each embodiment described and illustrated herein also includes its complementary embodiments. The term “and/or” used in the specification is used to include at least one of the elements listed before and after the “and/or”.

In the specification, a singular form may include a plural form if there is no clearly opposite meaning in the context. Further, it should be understood that term “include” or “have” indicates that a feature, a number, a step, a component, or a combination thereof described in the specification is present, but do not exclude a possibility of presence or addition of one or more other features, numbers, steps, components, or combinations thereof. Further, in the specification, “connection” is used to include both indirect connection and direct connection of a plurality of components.

In the following description of the present disclosure, a detailed description of known configurations or functions incorporated herein will be omitted when it is determined that the detailed description may make the subject matter of the present disclosure unclear.

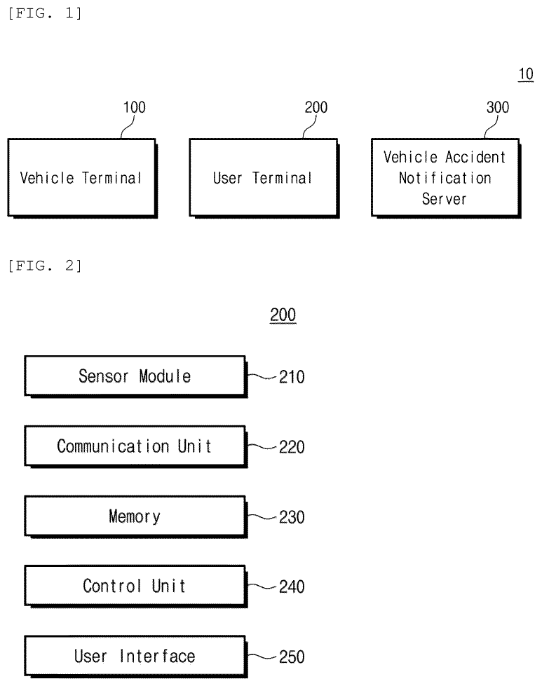

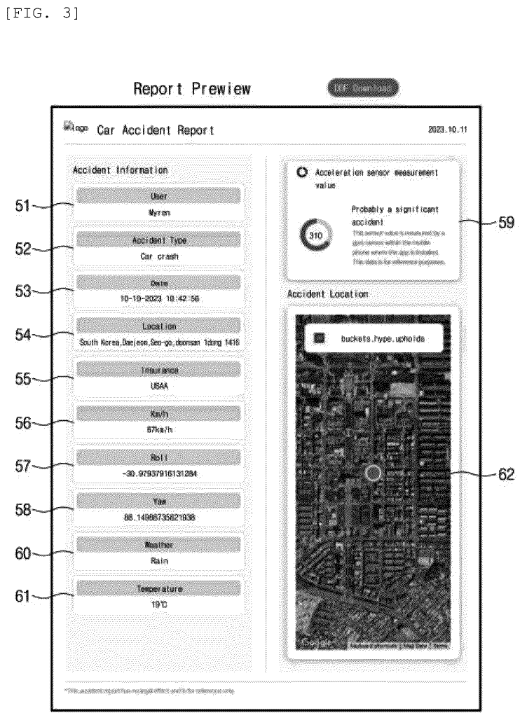

FIG. 1 is a view illustrating a vehicle accident detection and automatic reporting system according to an exemplary embodiment of the present disclosure and FIG. 2 is a view illustrating a detailed configuration of a user terminal of FIG. 1.

Referring to FIGS. 1 and 2, when an accident occurs in a vehicle in which a user rides, the vehicle accident detection and automatic reporting system 10 determines the occurrence of vehicle accident by a user terminal 200 using information measured by a vehicle terminal 100 and the user terminal 200 and transmits the occurrence of the vehicle accident to a vehicle accident notification server 300. The vehicle accident notification server 300 provides a vehicle accident notification service which transmits the vehicle accident to a predetermined accident response organization, such as insurance companies, emergency rescue organization, such as 119, vehicle towing companies, and other emergency contacts set by the user to allow the processing in response to the accident.

The vehicle accident detection and automatic reporting system 10 includes a vehicle terminal 100, a user terminal 200, and a vehicle accident notification server 300.

The vehicle terminal 100 is mounted in the vehicle and collects vehicle driving information. The vehicle terminal 100 collects electric/electron operating statuses of the vehicle. Specifically, the vehicle terminal 100 collects a vehicle driving speed, driving location information, mileage information, RPM, brake signal information, gas pedal signal information, vehicle inside temperature information, and vehicle outside temperature information. The vehicle terminal 100 wirelessly communicates with the user terminal 200. According to an exemplary embodiment, the vehicle terminal 100 communicates with the user terminal 200 via Bluetooth communication. According to the exemplary embodiment, the vehicle terminal 100 uses on-board diagnostics (OBD).

The user terminal 200 is a terminal owned by a user who rides in the vehicle and is located in the vehicle while the vehicle is being driven. The user terminal 200 may be carried by the user who is on board or may be installed in the vehicle. The user terminal 200 may be various types of terminals or electronic equipment which perform data communication in a wired or wireless manner, such as mobile phones, smart phones, or tablet PCs. The user terminal 200 may be connected to the vehicle terminal 100 and the vehicle accident notification server 200 via wireless communication.

The user terminal 200 includes a sensor module 210, a communication unit 220, a memory 230, a control unit 240, and a user interface 250.

The sensor module 210 senses movement information of the vehicle. The sensor module 210 includes an impact detection sensor module which senses an impact applied to the vehicle. For example, the impact detection sensor module is provided as an acceleration sensor. The acceleration sensor is provided as a tri-axial acceleration sensor and detects an up-to-down impulse, a front-to-back impulse, and a left-to-right impulse. The acceleration sensor may be controlled to adjust a sensitivity of a sensor value according to the speed of the vehicle. The acceleration sensor may adjust the sensitivity of a front-to-back impulse, and a left-to-right impulse to be larger than the sensitivity of the up-to-down impulse to improve the ability to discern accident judgment. For example, when the vehicle passes through a bump, the up-to-down impulse is larger than the left-to-right impulse or the front-to-back impulse so that the sensitivity of the up-to-down impulse is set to be lower than the left-to-right impulse or the front-to-back impulse in a low speed mode.

Further, the impact detection sensor module includes an acceleration sensor and a gyro sensor. Accordingly, the accuracy of detecting a status, such as change in vehicle speed during the driving, sudden braking of the vehicle, and sharp turning or overturning of the vehicle due to impact may be improved. For example an overturning type may be determined using speed change in a vertical direction and speed change in a horizontal direction of the vehicle. In order to more accurately determine overturning type, any one of a magnitude change of yaw and roll sensed by the gyro sensor and vertical acceleration sensed by the acceleration sensor. Here, the overturning type is determined as a slope way mode when the vehicle spins while traveling along a slope way with one of a right side or a left side of the vehicle, a ditch mode when a vehicle enters a downhill slope, such as an embankment, and rotates, a bump mode when a vehicle spins after getting caught on a bumpy part such as a curb side of the road in a lateral direction, and a sand mode when a vehicle enters a road surface having a high frictional coefficient, such as sands, and spins by getting caught on the side. When it is not determined as any one of the overturning types, it is determined as an auxiliary mode.

The sensor module 210 may further include a location sensor module. The location sensor module senses location change of the vehicle. Further, a speed of the vehicle may be calculated by the location change of the vehicle sensed by the location sensor module. The location detection sensor may be a GPS sensor.

The sensor module 210 may further include a gravity sensor and a geomagnetic sensor. The gravity sensor senses an up-down position of the user terminal 200 and the geomagnetic sensor senses an azimuth.

The memory 230 stores various data, such as a program for a client to use a vehicle accident notification service, data which operates the program for a client, data received from the vehicle accident notification server 300, and a sensing value of the sensor module 110. Further, the memory 130 may store pattern information. The pattern information is the basis of determining whether vehicle accident occurs and is provided as a data pattern. Further, the pattern information is updated by data transmitted from the vehicle accident notification server 300. The pattern information includes impulse pattern information. The impulse pattern information is provided as individual impulse pattern type in a vehicle normal state or a vehicle abnormal state. The impulse pattern information may include a pattern type of up-down impulse, front-rear impulse, and left-right impulse. Further, the impulse pattern information includes a gradient pattern shape corresponding to a sensing value of the gyro sensor. Further, the impulse pattern information is provided to allocate an impulse pattern type according to the vehicle speed. Further, the pattern information includes sound pattern information. The sound pattern information is provided as individual sound pattern type in a vehicle normal state or a vehicle abnormal state. Further, the sound pattern information is provided to allocate a sound pattern type according to the vehicle speed. Here, the memory 230 is a general term of a non-volatile memory which consistently maintains stored information even without supplying the power.

The control unit 240 executes a client program stored in the memory 230 and applies data received from the vehicle terminal 100, data sensed by the sensor module 210, data received from the vehicle accident notification server 300, and data stored in the memory 230 to the program. When the vehicle speed is equal to or higher than a reference speed, the control unit 240 automatically executes the program for client. According to the exemplary embodiment, when the vehicle speed is equal to or higher than 15 km/h, the control unit 240 automatically executes the program for client. When the program for client is executed, an alarm indicating that a real-time accident detection mode is operating is displayed on the display of the user terminal 200. The program for client performs a series of processes from accident determination to accident report.

The control unit 240 determines whether accident occurs in a vehicle through data received from the vehicle terminal 100 and data sensed by the sensor module 210 using a previously trained AI deep learning algorithm and if it is determined that the accident occurs, transmits accident data to the vehicle accident notification server 300 through the communication unit 230.

The control unit 240 primarily determines whether an accident has occurred in the vehicle using data received from the vehicle terminal 100 and secondarily determines whether the accident has occurred in the vehicle using data received from the sensor module 210. The control unit 240 sequentially performs primary determination and secondary determination on whether accident has occurred. The control unit 240 monitors a vehicle status and whether an accident has occurred while the client program is executed in the background and if the accident occurrence is detected, transmits accident data to the vehicle accident notification server 300.

FIG. 3 is a view illustrating a detailed configuration of a control unit according to an exemplary embodiment of the present disclosure.

Referring to FIG. 3, the control unit 240 includes a recording unit 241, an accident detection unit 242, a report generation unit 243, and an accident notification unit 244.

The recording unit 241 records surrounding sounds. That is, the recording unit 241 records sounds generated from the vehicle while driving the vehicle, through a microphone which is provided in the user terminal 200 or is connected to the user terminal 200 and also records impact sounds, glass breaking sounds which occur when the vehicle collides with other object in the event of the accident.

The accident detection unit 242 detects whether an accident occurs by comparing values measured from the vehicle terminal 100 and the sensor module 210 and pattern information using a previously trained AI deep learning algorithm. Specifically, the accident detection unit 242 compares the value measured from the vehicle terminal 100 and the sensor module 210 with the impulse pattern information and if a matching degree is equal to or larger than a predetermined value, determines that the accident occurs. At this time, when the impulse pattern information is allocated according to the vehicle speed, the accident detection unit 242 reflects the vehicle speed. Further, the accident detection unit 242 compares a sound stored through the recording unit 241 and sound pattern information to further reflect the matching degree to accident detection.

If the accident detection unit 242 determines that the accident occurs, the report generation unit 243 generates an accident report using vehicle driving information generated in the vehicle terminal 100 and vehicle movement information generated in the sensor module 210.

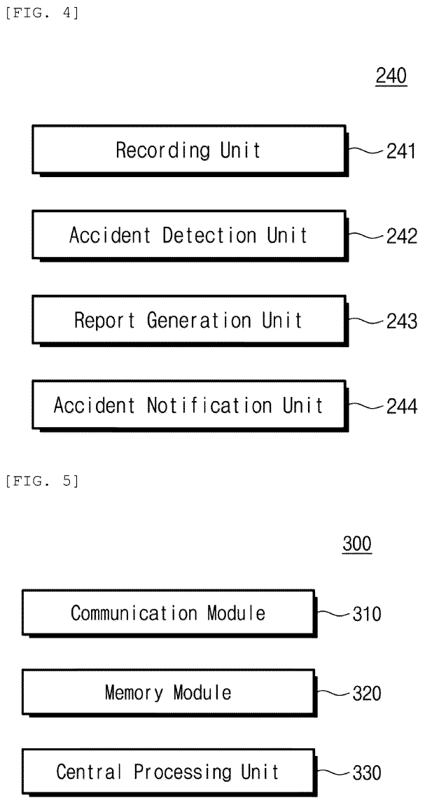

FIG. 4 is a view illustrating information included in an accident report according to an exemplary embodiment of the present disclosure.

Referring to FIG. 4, the accident report 50 includes driver information 51, accident type information 52, accident time information 53, accident location information 54, vehicle insurance information 55, vehicle body movement information 56, 57, 58, and 59, weather information 60, temperature information 61, and satellite photograph information 62 of an accident occurrence point. Further, even though it is not illustrated in the drawing, the accident report 50 further includes vehicle identification information.

The driver information 51 is user information stored in the user terminal 200 and includes name, age, gender, height, weight, a blood type, driver license information, and driving experience information.

The accident type information 52 refers to an accident type calculated using information measured by the vehicle terminal 100 and the sensor module 210 and topographic information of the vehicle driving location. The accident type information 52 is displayed by whether the vehicle accident is vehicle-to-vehicle collision accident, a vehicle-to-person collision accident, a vehicle-to-surrounding facility collision accident, or a vehicle overturning accident.

The accident time information 53 is time information when a vehicle impact is detected and includes year/month/day/time information.

The accident location information 54 is geographic location information where the vehicle accident occurs and includes GPS information and address information.

The vehicle body movement information 56, 57, 58, and 59 is vehicle body movement information immediately before vehicle accident occurrence and immediately after vehicle accident occurrence and includes a vehicle body speed 56, roll 57, yaw 58, and acceleration information 59. The vehicle body movement information 56, 57, 58, and 59 may be calculated by inputting information measured by the vehicle terminal 100 and the sensor module 210 to a previously stored algorithm. The vehicle body movement information separately displays yaw, roll, and acceleration and is displayed by numerical values or a graph.

The weather information 60 refers to weather information of a region where the vehicle accident occurs.

The temperature information 61 refers to temperature of a region where the vehicle accident occurs.

The satellite photograph information 62 of the accident occurrence point is provided by displaying a location of the vehicle on a satellite photograph of a location where the vehicle accident occurs.

The vehicle identification information includes information about a vehicle type, year, and a plate number.

When it is determined that vehicle accident occurs, the report generation unit 243 displays an accident occurrence confirmation message on the display of the user terminal 200 for a predetermined time and when the user touches the message, checks the message, or a predetermined time elapses, generates the accident report 50. The predetermined time may be set to 20 seconds to 40 seconds. Further, the predetermined time may be provided to be adjusted after the user executes the client program.

The accident notification unit 244 transmits the accident data and the accident report 50 to the vehicle accident notification server 20 when the user touches the message displayed on the display, checks the message, or a predetermined time elapses.

Referring to FIG. 2 again, the user interface 250 includes a display and displays a state of the user terminal 200 and a state of the client program. Further, the user interface 250 includes a touch panel and a keyboard to allow the user to directly input data for manipulating the user terminal 200.

The vehicle accident notification server 300 is connected to the user terminal 200 and servers of the accident response organizations via a network and has a connection structure to allow information exchange between nodes.

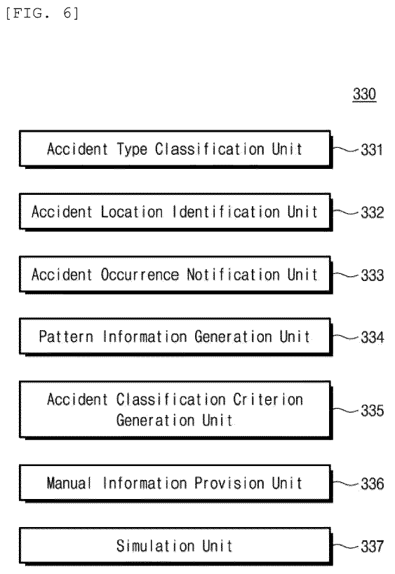

FIG. 5 is a view illustrating a vehicle accident notification server according to an exemplary embodiment of the present disclosure.

Referring to FIG. 5, the vehicle accident notification server 300 includes a communication module 310, a memory module 320, and a central processing unit 330.

The communication module 310 is provided to perform wired/wireless data communication via the network and transmits and receives data to and from the user terminal 200. The communication module 310 receives accident data and accident report from the user terminal 200 and transmits accident notification data to a server or a terminal of a related organization. At this time, the accident notification data and the accident report is data to inform insurance companies, emergency rescue organizations, such as 119, vehicle towing companies, and other emergency contact set by the user of the accident occurrence.

The memory module 320 stores received data, a program for providing a vehicle accident notification service, processing data generated by processing received data, a program for performing accident simulation, and various data. Here, the memory module 320 is a general term of a non-volatile memory which consistently maintains stored information even without supplying the power.

The central processing unit 330 executes a program stored in the memory module 320 and applies the stored data to the program. The central processing unit 330 is understood as a processor which controls the communication module 310 and the memory module 320 and reads out and processes data received through the communication module 310 or stored in the memory module 320 according to a predetermined program.

FIG. 6 is a view illustrating a detailed configuration of a central processing unit according to an exemplary embodiment of the present disclosure.

Referring to FIG. 6, the central processing unit 330 includes an accident type classification unit 33, an accident location identification unit 332, an accident occurrence notification unit 333, a pattern information generation unit 334, an accident classification criterion generation unit 33, a manual information provision unit 336, and a simulation unit 337.

The accident type classification unit 331 classifies an accident type of the vehicle based on received accident data and a predetermined accident type classification criterion. For example, the accident type classification unit 331 automatically classifies the type of accident, such as whether the current vehicle accident is caused by signal violation, crossing violation, violation of central line, sudden lane change, obstacle, or parking terror, a simple minor collision accident, or an accident involving in a collision with two-wheeled vehicle or a person. Further, the accident type classification unit 331 classifies accident types into rapid acceleration, sudden stop, rear-end collision, overturning, and complete lane departure. This may be applied when the vehicle in which the user rides is a mobility or a personal mobility. The mobility is applied to vehicles and taxis and the personal mobility is applied to electric kickboards and bicycles. Further, the accident type classification unit 331 classifies accident types into falling, tripping, rolling, and walking off. This may be applied when the vehicle in which the user rises is a green mobility or the user is walking. The green mobility includes electric wheelchair and wheelchair and a pedestrian may be faculty and students.

The accident location identification unit 332 performs a function of identifying a current accident occurrence location based on the received accident data. That is, the accident location identification unit 332 identifies the accident occurrence location by the location of the current vehicle detected by the location detection sensor at the accident data sending timing included in the accident data.

The accident occurrence notification unit 333 transmits the accident notification data to a predetermined accident response organization. That is, the accident occurrence notification unit 333 is provided with URL addresses or phone numbers to transmit accident notification data to insurance companies, PM companies, emergency rescue organizations, such as 119, vehicle towing companies, school control centers, living lab centers, emergency organizations, family/acquaintances, and other emergency contacts set by users. Accident notification data is transmitted to each organization

The pattern information generation unit 334 generates a pattern between accident data and actual accident occurrence. That is, the pattern information generation unit 334 defines accident data as an input factor and defines an output of the accident detection unit 242 as an output factor and then derives correlation between the input factor and the output factor to generate pattern information. The pattern information generation unit 334 is implemented by deep learning based on a deep neural network to derive correlation between the input factor and the output factor. Further, the pattern information generation unit 334 updates the existing pattern information with new pattern information. When the pattern information is updated, the pattern information generation unit 334 transmits the updated pattern information to the user terminal 200 so that the accident detection unit 242 detects whether the accident occurs using the updated pattern information.

The accident classification criterion generation unit 335 generates an accident type classification criterion. That is, the accident classification criterion generation unit 335 defines accident data as an input factor and defines output of the accident type classification unit 331 as an output factor, and then derives correlation between the input factor and the output factor to generate an accident type classification criterion. Further, the accident classification criterion generation unit 335 updates the existing accident type classification criterion with a new accident type classification criterion. The accident classification criterion generation unit 335 is implemented by deep learning based on a deep neural network to derive correlation between the input factor and the output factor.

The manual information provision unit 336 transmits an accident response manual to the user terminal 200. The response manual may be provided as text information displayed on the user terminal 200 or voice information output through a speaker provided in the user terminal 200. The response manual includes notification information about a situation that the accident notification data is notified to a predetermined organization, notification information guiding to capture the accident scent for post-accident processing, and information guiding to move and wait in a safe place. When the accident data is automatically sent from the accident notification unit 224 of the user terminal 200 as the sending standby state maintaining period has elapsed, the manual information provision unit 336 transmits consciousness confirmation message to confirm whether the user is conscious to the user terminal 200. If a response to the consciousness confirmation message is not received within a predetermined period, a message indicating that the user loses consciousness is transmitted to the accident notification unit 244 and the accident notification unit 224->244 further transmits an emergency message indicating it may be an emergency situation to a predetermined organization.

The simulation unit 337 performs simulation using accident data received from the user terminal 200. For example, the simulation unit 337 provides to perform the simulation based on the mathematical dynamic model (MADYMO) program. The simulation unit 337 performs a function of analyzing a cause of the vehicle accident through a 3D simulation using the received accident data and determining a causal relationship with injury. Thereafter, the simulation result is provided to the accident processing related organization to accurately determine the situation. The simulation unit 337 is provided to perform the simulation for each of different simulation conditions. That is, the simulation unit 337 includes various data required for behavior analysis of the vehicle passenger, such as data about a vehicle type and a structure of the vehicle according to the vehicle type, data about a dummy used for the experiment, data about safety parts, and data about vehicle motion characteristic at the time of collision. Desirably, a test condition according to each vehicle type is provided as a database so that the simulation for various vehicle types may be quickly performed.

When the accident occurs, the vehicle accident notification system 10 according to the exemplary embodiment of the present disclosure is provided to notify an organization for accident response of the accident occurrence after the accident occurrence is detected by the vehicle terminal 100 and the user terminal 200 and then the accident occurrence is notified to the vehicle accident notification server 300. Therefore, as compared with a case when the user directly informs the organization of the accident occurrence for accident response, the accident occurrence fact is quickly notified to each organization to handle the accident. Specifically, the vehicle accident notification system according to an exemplary embodiment of the present disclosure enables significantly quickly accident notification and accident handling by considering the fact that when the accident occurs, the drive becomes confused.

Further, the vehicle accident notification system 10 according to an exemplary embodiment of the present disclosure notifies an organization handing the accident of the accident occurrence fact even when the driver loses consciousness due to the accident to quickly notify the accident and rescue the driver even when the driver loses consciousness.

Further, the vehicle accident notification system 10 according to the exemplary embodiment of the preset disclosure provides safety integration data management based server and data analysis and related service based on the AI deep learning. The safety integrated data management-based service can perform safety data linkage collection system, integrated big data construction, and infrastructure system operation and management. The data analysis and linkage system provides an AI based risk section analysis system, a GIS safety analysis system, and related organization data linkage/sharing service.

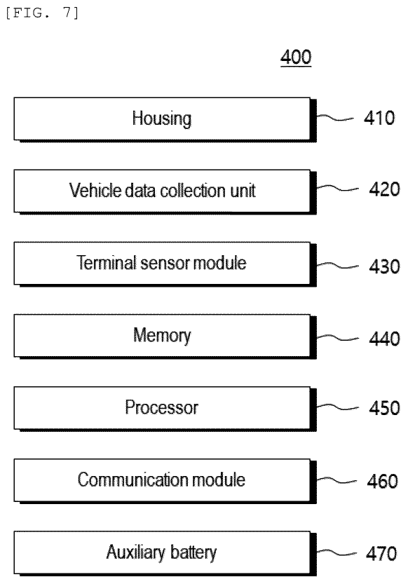

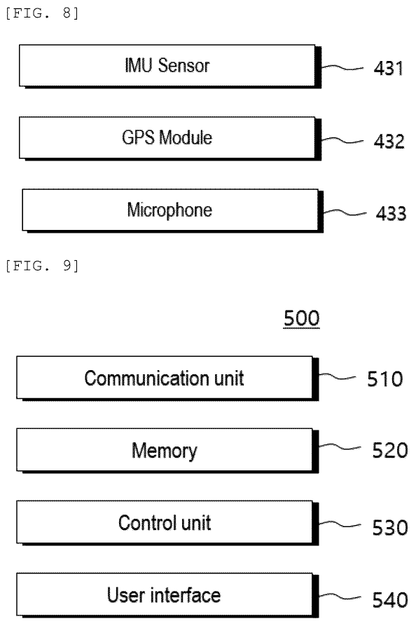

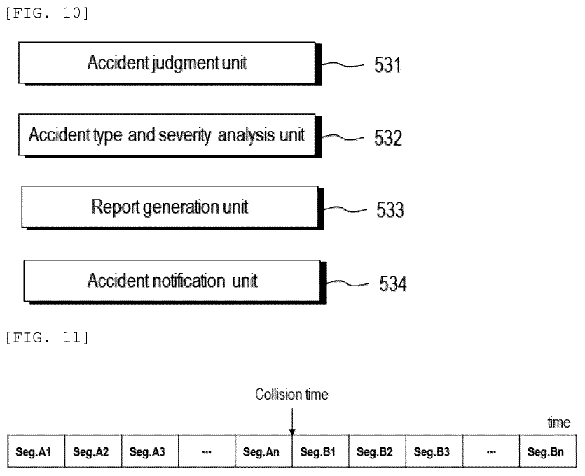

FIG. 7 is a view illustrating a detailed configuration of a vehicle terminal according to another exemplary embodiment of the present disclosure, FIG. 8 is a view illustrating a detailed configuration of a terminal sensor module of FIG. 7, FIG. 9 is a view illustrating a detailed configuration of a user terminal according to another exemplary embodiment of the present disclosure, and FIG. 10 is a view illustrating a detailed configuration of a control unit according to an exemplary embodiment of the present disclosure of FIG. 9.

Referring to FIGS. 7 to 10, the vehicle terminal 400 is mounted in the vehicle. The vehicle terminal 400 includes a housing 410, a vehicle data collection unit 420, a terminal sensor module 430, a memory 440, a processor 450, a communication module 460, and an auxiliary battery 470.

The housing 410 is provided with a predetermined shape and has a terminal which is electrically connected to an OBD connector mounted in the vehicle. The vehicle data collection unit 420, the terminal sensor module 430, the memory 440, a processor 450, a communication module 460, and an auxiliary battery 470 are provided in the housing.

The vehicle data collection unit 420 collects vehicle driving data. The vehicle data collection unit 420 collects electric/electron operating statuses of the vehicle. The vehicle data collection unit 420 collects a vehicle driving speed, driving location data, mileage data, RPM, brake signal data, gas pedal signal data, vehicle inside temperature data, and vehicle outside temperature data. The collected data is stored in the memory 440.

The terminal sensor module 430 detects vehicle movement data and vehicle location data. The terminal sensor module 430 includes an inertia measurement sensor (IMU) 431 and a GPS module 433.

The inertia measurement sensor 431 includes a multi-axial accelerometer, for example, a bi-axial or tri-axial accelerometer. The inertia measurement sensor 431 further includes a gyroscope which is used to determine a direction of the vehicle terminal and/or a relative direction for the accelerometer data. By doing this, a collision detection function of the vehicle terminal 400 may be corrected.

The vehicle terminal 400 may measure a movement change in an x-axis, y-axis, and z-axis of the vehicle. The vehicle terminal 400 evaluates the direction of the vehicle terminal 400 with respect to a direction system of the vehicle in which the vehicle terminal 400 is mounted to correct the vehicle terminal 400. In order to identify whether a collision event occurs, the inertia measurement sensor 431 consistently collects and monitors an acceleration change which indicates the vehicle collision. The inertia measurement sensor 431 includes a unit for processing acceleration data. When the inertia measurement sensor 431 senses acceleration data including the vehicle collision, the inert measurement sensor 431 wakes up the processor 450 to be switched to an operation mode.

Further, the terminal sensor module 430 may further include a microphone 433. The microphone 433 receives surrounding sounds (audible and/or inaudible frequency range) in the vehicle.

The GPS module 432 receives a radio signal from an orbiting GPS satellite in the network and processes the radio signal through an integrated antenna. The GPS module 432 receives signal from at least three satellites of the GPS network to determine correct location data and movement data of the vehicle terminal 400 through an integrated microprocessor. Thereafter, the location data and the movement data are provided to the processor 450. The GPS module 432 is configured to generate location at a desired interval. According to the exemplary embodiment, the GPS module 432 generates the location data of the vehicle terminal 400 at every 10 seconds, 30 seconds, and every minute.

The memory 440 stores data collected in the vehicle data collection unit 420, data measured by the terminal sensor module 430, and various software. The memory 440 may be a computer readable storage medium which is provided to the processor 450. For example, the memory 440 may be a flash memory. Further, the memory 440 serves as a buffer memory to allow the processor 450 to consistently read and overwrite non-collision acceleration related data.

The processor 450 performs an algorithm which is stored in the memory 440 in advance and executes software. Further, the processor 450 may be any type of computer, controller, microcontroller, circuitry, chipset, microprocessor, processor system or computer system capable of loading and executing different types of computer programs.

According to the exemplary embodiment, the processor 450 analyzes data measured by the inertia measurement sensor 431 to determine vehicle collision, by performing the accident detection algorithm. The processor 450 determines that collision occurs if acceleration data in at least one or more axes, among data measured by the inertia measurement sensor 431, exceeds a threshold acceleration value or a value measured by the gyroscope exceeds a threshold value.

When it is determined that vehicle collision occurs, the processor 450 calculates a collision time and calculates vehicle location data at the collision time from the location data received by the GPS module 432. Here, the collision time is a time at which a measurement value measured by the inertia measurement sensor 431 or the gyroscope begins to change due to the vehicle collision.

When it is determined that the vehicle collision occurs, the processor 450 extracts pre-vehicle collision data obtained for a predetermined time before the collision time and post-vehicle collision data obtained for a predetermined time after the collision time.

The pre-vehicle collision data includes vehicle driving data before the collision time collected by the vehicle data collection unit 420, acceleration data of the vehicle terminal 400 before the collision time measured by the inertia measurement sensor 431, and surrounding sound data before the collision time measured by the microphone 433.

The post-vehicle collision data includes vehicle driving data after the collision time collected by the vehicle data collection unit 420, acceleration data of the vehicle terminal 400 after the collision time measured by the inertia measurement sensor 431, and surrounding sound data after the collision time measured by the microphone 433.

The communication module 460 is wirelessly connected to the user terminal 500 and transmits data stored in the memory 440 and/or data processed by the processor 450 to the user terminal 500. According to the exemplary embodiment, the communication module 460 transmits the pre-vehicle collision data, the post-vehicle collision data, and the vehicle location information at the collision time output from the processor 450 to the user terminal 500. The communication module 460 communicates with the user terminal 500 through Bluetooth communication.

When the power supply from the vehicle is cut, the auxiliary battery 470 supplies the power to the terminal sensor module 430, the memory 440, the processor 450, and the communication module 460. The auxiliary battery 470 is supplied with the power from the vehicle to charge the power while the vehicle terminal 400 is mounted in the vehicle. When the vehicle normally operates, the power is supplied from the vehicle so that the terminal sensor module 430, the memory 440, the processor 450, and the communication module 460 operate. When the power supply from the vehicle is cut due to the vehicle collision, the power is supplied to the terminal sensor module 430, the memory 440, the processor 450, and the communication module 460 from the auxiliary battery 470.

The user terminal 500 includes a communication unit 510, a memory 520, a control unit 530, and a user interface 540.

The communication unit 510 wirelessly communicates with the vehicle terminal 400 and wirelessly communicates with the vehicle accident notification server 300. The communication unit 510 receives the pre-vehicle collision data, the post-vehicle collision data, and the vehicle location information at the collision time from the communication module 460 of the vehicle terminal 400. The communication unit 510 transmits vehicle accident data and the accident report to the vehicle accident notification server 300.

The memory 440 stores received data, a program for providing a vehicle accident notification service, processing data generated by processing received data, a program for performing accident simulation, and various data. The memory 400 may be all non-volatile computer readable storage medium which stores data and provides the data to the processor. For example, the memory 440 may be a flash memory.

The control unit 530 determines whether vehicle accident occurs, analyzes an accident type and severity, generates an accident report, and transmits the accident data and the accident report to the vehicle accident notification server 300.

The control unit 530 includes an accident judgment unit 531, an accident type and severity analysis unit 532, a report generation unit 533, and an accident notification unit 534.

The accident judgment unit 531 determines whether an accident occurs using a previously trained AI deep learning algorithm. The accident judgment unit 531 learns with pre-vehicle collision data and post-vehicle collision data as input data and compares the learning result with previously stored accident pattern information to determine whether accident occurs. When the accident judgment unit 531 determines that accident occurs, the accident judgment unit 531 controls the accident confirmation message to be displayed on a display of the user terminal 500 for a predetermined time.

When it is determined that the accident occurs, the accident type and severity analysis unit 532 analyzes vehicle accident type and severity using the previously trained AI deep learning algorithm.

The accident type information includes whether the vehicle accident is vehicle-to-vehicle collision accident, a vehicle-to-person collision accident, a vehicle-to-surrounding facility collision accident, or a vehicle overturning accident.

Further, the vehicle accident type includes offset collision, collision with hard objects, collision with soft objects, under-liner collision, frontal collision, side collision, local collision, and front collision.

The accident severity refers to a severity of the vehicle collision according to the above-described accident type and a severity of injury caused on the passenger.

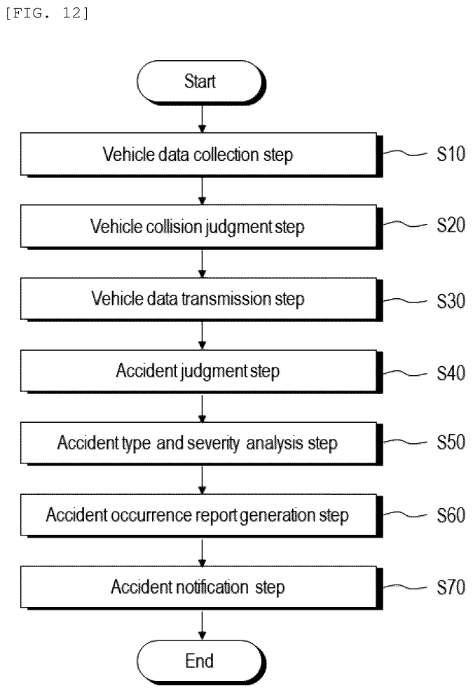

FIG. 11 is a view illustrating that pre-vehicle collision data and post-vehicle collision data are divided into a plurality of segments with respect to a collision time according to an exemplary embodiment of the present disclosure.

Referring to FIG. 11, the accident type and severity analysis unit 532 divides the pre-vehicle collision data and the post-vehicle collision data by a predetermined time interval, based on the collision time, to generate a plurality of segments Seg.A1 to Seg.Bn.

According to the exemplary embodiment, the accident type and severity analysis unit 532 generates the segments such that a number of segments Seg.B1 to Seg.Bn generated from the post-vehicle collision data is larger than a number of segments Seg.A1 to Seg.An generated from the pre-vehicle collision data.

According to another exemplary embodiment, the accident type and severity analysis unit 532 varies the time length to generate segments. Specifically, the closer to the collision time, the shorter the time length of the segments Seg.A1 to Seg.An generated from the pre-vehicle collision data and the closer to the collision time, the longer the segments Seg.B1 to Seg.Bn generated from the post-vehicle collision data and the further from the collision time, the longer the time length.

As described above, more segments Seg.B1 to Seg.Bn are generated from the post-vehicle collision data and more segments Seg.A1 to Seg.Bn are generated by shortening the time interval at a time adjacent to the collision time so that the accident type and severity analysis accuracy may be improved.

The accident type and severity analysis unit 532 may generate a plurality of driving speed segments by dividing vehicle driving speed data before vehicle collision and vehicle driving speed data after vehicle collision by a time interval. Here, the vehicle driving speed data is an actual vehicle driving speed collected by the vehicle data collection unit 420.

The accident type and severity analysis unit 532 may generate a plurality of driving speed segments by dividing acceleration data of the vehicle terminal 400 before vehicle collision and acceleration speed data of the vehicle terminal 400 after vehicle collision by a time interval. Here, the acceleration data of the vehicle terminal 400 is data measured by the inertia measurement sensor of the vehicle terminal 400 and the gyroscope.

The accident type and severity analysis unit 532 may generate a plurality of surrounding sound segments by dividing surrounding sound data before vehicle collision and surrounding sound data after vehicle collision by a time interval. Here, the surrounding sound data is voice data measured by the microphone 433 of the vehicle terminal 400.

The accident type and severity analysis unit 532 compresses a plurality of driving speed segments, a plurality of acceleration segments, and a plurality of surrounding sound segments to have a plurality of different sizes. According to the exemplary embodiment, the accident type and severity analysis unit 532 applies the convolution neural network (CNN) to compress the segments to have a plurality of sizes.

Specifically, the accident type and severity analysis unit 532 compresses the driving speed segments to have different sizes to generate a driving speed segment compression signal, compresses the acceleration segments to have different sizes to generate an acceleration segment compression signal, and compresses the surrounding sound segments to have different sizes to generate a surrounding sound segment compression signal.

The convolution neural network individually analyzes the data to train a data recognition model and converts the trained data into a vector using a convolution operation, and applies a plurality of filters to the converted vector data to generate a feature map. A size of the generated feature map is reduced using pooling by calculating a representative value of the data to reduce the effects of feature map size change, warping, and distortion.

The pooling reduces the size of the convolutional neural network by reducing the feature values of the feature map in the convolutional neural network to a single representative value, thereby reducing the space in the horizontal and vertical directions. Pooling is divided into max pooling and average pooling depending on the method of setting the representative value. Max pooling sets the maximum value among the feature values of the feature map as the representative value, and average pooling sets the average value of the feature values of the feature map as the representative value.

The accident type and severity analysis unit 543 adjusts a number of poolings of the convolution neural network to adjust a compression level of the driving speed segment compression signal, the acceleration segment compression signal, and the surrounding sound segment compression signal. Whenever pooling is applied 1, 2, 3, or 4 times to each of the driving speed segment compression signal, the acceleration segment compression signal, and the surrounding sound segment compression signal, each of the compression signals can be reduced by ½, ¼, ⅛, or 1/16.

The accident type and severity analysis unit 532 varies a number of pooling application times to the driving speed segment compression signal, the acceleration segment compression signal, and the surrounding sound segment compression signal. By doing this, the numbers of generated driving speed segment compression signals, acceleration segment compression signals, and surrounding sound segment compression signal and the compression level may vary. According to the exemplary embodiment, the accident type and severity analysis unit 532 applies the pooling to the driving speed segment compression signal and the acceleration segment compression signal more than the pooling to the surrounding sound segment compression signal.

The accident type and severity analysis unit 532 extracts feature points from the driving speed segment compression signal, the acceleration segment compression signal, and the surrounding sound segment compression signal and compares the extracted feature points with a previously ensured feature point of the accident type and severity to determine the accident type and severity. Here, the previously ensured feature point of the accident type and severity is data ensured by various actual accident examples and/or collision test processes and includes an accident type and a collision severity and injury information of the passenger according to the accident type.

The accident type and severity analysis unit 532 compares a feature point extracted from the driving speed segment compression signal and a previously ensured feature point of the driving speed to determine the accident type and the severity.

The accident type and severity analysis unit 532 compares a feature point extracted from the acceleration segment compression signal and a previously ensured feature point of the acceleration to determine the accident type and the severity.

Further, the accident type and severity analysis unit 532 compares a feature point extracted from the surrounding sound segment compression signal and a previously ensured feature point of the surrounding sound to determine the accident type and the severity.

The accident type and severity analysis unit 532 compares a feature point extracted from the driving speed segment compression signal and a feature point extracted from the acceleration segment compression signal to determine the accident type and the severity.

The driving speed segment compression signal is data obtained from the actual vehicle driving speed, but the acceleration segment compression signal is acceleration data measured in the vehicle terminal. When the vehicle collides, the actual vehicle driving speed change may be different from the acceleration data measured by the vehicle terminal 400. For example, in the case of minor collision or collision with a soft object, the collision energy is absorbed by the vehicle body so that the actual vehicle driving speed change may be different from the acceleration data measured by the vehicle terminal.

When a difference between the feature point extracted from the driving speed segment compression signal and the feature point extracted from the acceleration segment compression signal exceeds a threshold value, the accident type and severity analysis unit 532 determines as minor collision or collision with a soft object.

Further, the accident type and severity analysis unit 532 analyzes the accident type and severity using the following Equation 1.

$$L = α L 1 + β L 2 + γ L 3 \qquad [ Equation 1 ]$$

Here, α is a weight for a feature point extracted from a driving speed segment compression signal,
β is a weight for a feature point extracted from an acceleration segment compression signal, and
γ is a weight for a feature point extracted from a surrounding sound segment compression signal,
L1 is a difference value of a feature point extracted from the driving speed segment compression signal and a previously ensured feature point of a driving speed,
L2 is a difference value of a feature point extracted from the acceleration segment compression signal and a previously ensured feature point of an acceleration, and
L3 is a difference value of a feature point extracted from the surrounding sound segment compression signal and a previously ensured feature point of a surrounding sound.

According to the exemplary embodiment, the weight for a feature point extracted from a driving speed segment compression signal and the weight for a feature point extracted from an acceleration segment compression signal may be larger than the weight for a feature point extracted from a surrounding sound segment compression signal.

The report generation unit 533 generates an accident report. In addition to the information illustrated in FIG. 4, the accident report includes an accident type, an accident severity, and an injury severity of the passenger determined by the accident type and severity analysis unit.

As the accident type, at least any one of vehicle-to-vehicle collision, vehicle-to-person collision, vehicle-to-surrounding facilities, vehicle overturning accident, offset collision, collision with hard objects, collision soft objects, under-liner collision, frontal collision, side collision, local collision, and front collision is displayed.

In the accident severity, a damage degree of the vehicle due to the collision is represented as a numerical value or a level.

In the injury severity of the passenger, an injury degree of the passenger due to the collision is represented as a numerical value or a level.

The accident notification unit 534 transmits the accident notification data and the accident report to a predetermined accident response organization.

FIG. 12 is a flowchart illustrating a method of detecting and automatically reporting a vehicle accident using a vehicle terminal and a user terminal according to an exemplary embodiment of FIGS. 7 to 11.

Referring to FIG. 12, the vehicle accident detecting and automatically reporting method includes a vehicle data collection step S10, a vehicle collision judgment step S20, a vehicle data transmission step S30, an accident judgment step S40, an accident type and severity analysis step S50, an accident occurrence report generation step S60, and an accident notification step S70.

In the vehicle data collection step S10, vehicle driving data, acceleration data, GPS data, and surrounding sound data are collected.

The vehicle driving data is collected from the vehicle by the vehicle data collection unit 420. The vehicle driving data includes a vehicle driving speed, driving location data, mileage data, RPM, brake signal data, gas pedal signal data, vehicle inside temperature data, and vehicle outside temperature data.

The acceleration data is collected by the inertia measurement sensor 431 of the vehicle terminal 400. The acceleration data is obtained by measuring an acceleration change in an x-axis, y-axis, and z-axis of the vehicle. When acceleration data representing vehicle collision is detected, the inertia measurement sensor 431 wakes up the processor to be switched to an operation mode.

As the GPS data, accurate location data and movement data of the vehicle terminal 400 are collected by the GPS module 432.

The vehicle collision judgment step S20 is performed when the processor 450 is switched to the operation mode by the inertia measurement sensor 431. In the vehicle collision judgment step S20, the processor 450 performs the collision detection algorithm and analyzes data measured by the inertia measurement sensor 431 to determine vehicle collision. The processor 450 determines that collision occurs if acceleration data in at least one or more axes, among data measured by the inertia measurement sensor 431, exceeds a threshold acceleration value or data measured by the gyroscope exceeds a threshold value.

When it is determined that collision occurs, the processor 450 calculates a collision time and calculates vehicle location data at the collision time from the location data received by the GPS module 432.

When it is determined that the vehicle collision occurs, the processor 450 extracts pre-vehicle collision data obtained for a predetermined time before the collision time and post-vehicle collision data obtained for a predetermined time after the collision time.

The pre-vehicle collision data includes vehicle driving data before the vehicle collision collected by the vehicle data collection unit 420, acceleration data of the vehicle terminal 400 before the vehicle collision measured by the inertia measurement sensor 431, and surrounding sound data before the vehicle collision measured by the microphone 433.

The post-vehicle collision data includes vehicle driving data after the vehicle collision collected by the vehicle data collection unit 420, acceleration data of the vehicle terminal 400 after the vehicle collision measured by the inertia measurement sensor 431, and surrounding sound data after the vehicle collision measured by the microphone 433.

In the vehicle data transmission step S30, the pre-vehicle collision data, the post-vehicle collision data, and the vehicle location data at the collision time output from the processor 450 are transmitted to the user terminal 500.

In the accident judgment step S40, the control unit 530 of the user terminal 500 determines whether accident occurs using a previously trained AI deep learning algorithm. In the accident judgment step S40, learning is performed with pre-vehicle collision data and post-vehicle collision data as input data and compares the learning result with previously stored accident pattern information to determine whether accident occurs.

When it is determined that the accident occurs, the accident confirmation message is displayed on the display of the user terminal 500 for a predetermined time.

Simultaneously, the accident type and severity analysis step is performed.

In the accident type and severity analysis step S50, the control unit 530 analyzes vehicle accident type and severity using the previously trained AI deep learning algorithm.

Specifically, the control unit 530 generates a plurality of segments Seg.A1 to Seg.Bn by dividing a pre-vehicle collision data and a post-vehicle collision data by a predetermined time interval based on the collision time. Further, the control unit 530 generates the segments such that a number of segments Seg.B1 to Seg.Bn generated from the post-vehicle collision data is larger than a number of segments Seg.A1 to Seg.An generated from the pre-vehicle collision data.

Further, the control unit 530 generates the segments such that the closer to the collision time, the shorter the time length of the segments Seg.A1 to Seg.An generated from the pre-vehicle collision data. Further, the control unit 530 generates the segments such that the closer to the collision time, the shorter the time length of the segments Seg.B1 to Seg.Bn generated from the post-vehicle collision data and the further from the collision time, the longer the time length.

The control unit 530 may generate a plurality of driving speed segments by dividing vehicle driving speed data before vehicle collision and vehicle driving speed data after vehicle collision by a time interval.

The control unit 530 may generate a plurality of driving speed segments by dividing acceleration data of the vehicle terminal 400 before vehicle collision and acceleration speed data of the vehicle terminal 400 after vehicle collision by a time interval.

The control unit 530 may generate a plurality of surrounding sound segments by dividing surrounding sound data before vehicle collision and surrounding sound data after vehicle collision by a time interval.

The control unit 530 compresses a plurality of driving speed segments, a plurality of acceleration segments, and a plurality of surrounding sound segments to have a plurality of different sizes. The control unit 530 applies the convolution neural network CNN to compress the segments to have a plurality of different sizes.

According to the exemplary embodiment, the control unit 530 compresses the driving speed segments to have different sizes to generate a driving speed segment compression signal, compresses the acceleration segments to have different sizes to generate an acceleration segment compression signal, and compresses the surrounding sound segments to have different sizes to generate a surrounding sound segment compression signal.

The control unit 530 adjusts a number of poolings of the convolution neural network to adjust a compression level of the driving speed segment compression signal, the acceleration segment compression signal, and the surrounding sound segment compression signal.

Whenever pooling is applied 1, 2, 3, or 4 times to each of the driving speed segment compression signal, the acceleration segment compression signal, and the surrounding sound segment compression signal, each of the compression signals can be reduced by ½, ¼, ⅛, or 1/16.

The control unit 530 varies a number of pooling application times to the driving speed segment compression signal, the acceleration segment compression signal, and the surrounding sound segment compression signal. By doing this, the numbers of generated driving speed segment compression signals, acceleration segment compression signals, and surrounding sound segment compression signal and the compression level may vary.

The control unit 530 extracts feature points from the driving speed segment compression signal, the acceleration segment compression signal, and the surrounding sound segment compression signal and compares the extracted feature points with the previously ensured feature point of the accident type and severity to determine the accident type and severity.

The control unit 530 compares a feature point extracted from the driving speed segment compression signal and a previously ensured feature point of the driving speed to determine the accident type and the severity.

The control unit 530 compares a feature point extracted from the acceleration segment compression signal and a previously ensured feature point of the acceleration to determine the accident type and the severity.

The control unit 530 compares a feature point extracted from the surrounding sound segment compression signal and a previously ensured feature point of the surrounding sound to determine the accident type and the severity.

The control unit 530 compares a feature point extracted from the driving speed segment compression signal and a feature point extracted from the acceleration segment compression signal to determine the accident type and the severity.

The control unit analyzes the accident type and severity using Equation 1.

The control unit makes the weight for a feature point extracted from a driving speed segment compression signal and the weight for a feature point extracted from an acceleration segment compression signal larger than the weight for a feature point extracted from a surrounding sound segment compression signal to analyze the accident type and severity.

When the accident type and severity analysis is completed, the accident occurrence report generation step S60 is performed.

In the accident occurrence report generation step S60, an accident report is generated. The accident report includes driver information, accident type information, accident severity information, passenger injury severity information, accident occurrence time information, accident occurrence location information, vehicle identification information, vehicle insurance information, vehicle body movement information, weather information, temperature information, and satellite photograph information of the accident occurrence location.

In the accident notification step S70, the accident notification data and the accident report are transmitted to a predetermined accident response organization.

The apparatus according to the exemplary embodiments of the present disclosure includes a processor, a permanent storage which stores and executes program data such as a memory or a disk driver, a communication port which communicates with the external device, and a user interface such as a key or a button. Methods which are implemented by a software module or an algorithm may be computer readable codes or program instructions which are executable on the processor and stored on a computer readable recording medium. Here, the computer readable recording medium may include a magnetic storage medium such as a read only memory (ROM), a random access memory (RAM), a floppy disk, and hard disk and an optical reading medium such as CD-ROM or digital versatile disc (DVD). Digital Versatile Disc)). The computer readable recording medium is distributed in computer systems connected through a network so that computer readable code is stored therein and executed in a distributed manner. The medium is readable by the computer, is stored in the memory, and is executed in the processor.

Exemplary embodiments of the present disclosure may be represented with functional block configurations and various processing steps. The functional blocks may be implemented by various numbers of hardware and/or software configurations which execute specific functions. For example, the exemplary embodiment may employ integrated circuit configurations such as a memory, a processing, a logic, or a look-up table in which various functions are executable by the control of one or more microprocessors or the other control devices. Similar to execution of the components of the present disclosure with software programming or software elements, the exemplary embodiment may be implemented by programming or scripting languages such as C, C++, Java, assembler including various algorithms implemented by a combination of data structures, processes, routines, or other program configurations. The functional aspects may be implemented by an algorithm executed in one or more processors. Further, the exemplary embodiment may employ the related art for the electronic environment setting, signal processing and/or data processing. The terms such as “mechanism”, “element”, “unit”, and “configuration” are broadly used and are not limited to mechanical and physical configurations. The terms may include meaning of a series of routines of a software in association with the processor.

Specific executions described in the exemplary embodiments are examples, so that the range of the exemplary embodiment is not limited by any way. For simplicity of the specification, the description of another functional aspects of the electronic configurations, control systems, software, and the systems of the related art may be omitted. Further, connections of components illustrated in the drawing with lines or connection members illustrate functional connection and/or physical or circuit connections. Therefore, in the actual apparatus, it is replaceable or represented as additional various functional connections, physical connections, or circuit connections. Unless specifically stated as “essential”, “importantly”, it may not be an essential configuration to apply the present disclosure.

For now, the present disclosure has been described with reference to the exemplary embodiments. It is understood to those skilled in the art that the present disclosure may be implemented as a modified form without departing from an essential characteristic of the present disclosure. Therefore, the disclosed exemplary embodiments may be considered by way of illustration rather than limitation. The scope of the present disclosure is presented not in the above description but in the claims and it may be interpreted that all differences within an equivalent range thereto may be included in the present disclosure.

What is claimed is:

1. A vehicle accident detection and automatic reporting system, comprising:
a vehicle terminal which is mounted in a vehicle and acquires driving information of the vehicle; and
a user terminal owned by a user who rides in the vehicle,
wherein the user terminal includes:
a sensor module which detects movement information of the vehicle;
a communication unit which communicates with the vehicle terminal and receives the vehicle driving information; and
a control unit which determines whether an accident of the vehicle occurs using the vehicle driving information and the vehicle movement information.

2. The vehicle accident detection and automatic reporting system according to claim 1, wherein the control unit includes a report generation unit which when it is determined that the accident of the vehicle occurs, generates an accident report using the vehicle driving information and the vehicle movement information.

3. The vehicle accident detection and automatic reporting system according to claim 2, wherein the accident report includes driver information, vehicle identification information, accident type information, accident occurrence location information, vehicle accident time information, weather information, body movement information, and satellite photograph information of the accident occurrence point.

4. The vehicle accident detection and automatic reporting system according to claim 3, wherein the vehicle movement information includes yaw, roll, and acceleration information of a vehicle body.

5. The vehicle accident detection and automatic reporting system according to claim 2, further comprising:
a vehicle accident notification server which receives the accident report from the communication unit and transmits the accident report to an accident response organization.

6. The vehicle accident detection and automatic reporting system according to claim 2, wherein when it is determined that the vehicle accident occurs, the control unit displays an accident occurrence confirmation message on a display of the user terminal for a predetermined time and the report generation unit generates the accident report at the time when the user checks the accident occurrence confirmation message or the predetermined time elapses.

7. A vehicle accident detection and automatic reporting system, comprising:
a vehicle terminal which is connected to an OBD connector mounted in a vehicle; and
a user terminal which is communicable with the vehicle terminal and is owned by a user who rides in the vehicle,
wherein the vehicle terminal includes:
a driving information collection unit which collects the vehicle driving data from the OBD connector;
an inertia measurement sensor which measures acceleration data of the vehicle terminal;
a processor which determines vehicle collision calculates a collision time, and extracts pre-vehicle collision data obtained for a predetermined time before the collision time and post-vehicle collision data obtained for a predetermined time after the collision time using acceleration data measured by the inertia measurement sensor; and
a communication module which is communicable with the vehicle terminal and transmits the pre-vehicle collision data and the post-vehicle collision data to the user terminal.

8. The vehicle accident detection and automatic reporting system according to claim 7, wherein the vehicle terminal further includes:
a GPS module which receives location data of the vehicle terminal and the communication module transmits the location data at the collision time to the user terminal.

9. The vehicle accident detection and automatic reporting system according to claim 7, wherein the user terminal includes:
an accident judgment unit which trains a previously trained AI deep learning algorithm with pre-vehicle collision data and post-vehicle collision data as input data and compares the learning result with previously stored accident pattern information to determine whether accident occurs;
an accident type and severity analysis unit which uses a previously trained AI deep learning algorithm to divide the pre-vehicle collision data and the post-vehicle collision data by a predetermined time interval based on the collision time to generate a plurality of segments and compress the segments to have different sizes to generate a segment compression signal, extract a feature point from each segment compression signal, and compare the feature point with a feature point of the previously accident type and severity to determine the accident type and severity.

10. The vehicle accident detection and automatic reporting system according to claim 9, wherein the accident type and severity analysis unit divides the segments such that the closer to the collision time, the shorter the time length of the segments generated from the pre-vehicle collision data and the post-vehicle collision data and the further from the collision time, the longer the time length of the segments generated from the pre-vehicle collision data and the post-vehicle collision data at the collision time.

11. The vehicle accident detection and automatic reporting system according to claim 9, wherein the segment compression signal includes a driving speed segment compression signal and an acceleration segment compression signal and when a difference between the feature point extracted from the driving speed segment compression signal and the feature point extracted from the acceleration segment compression signal exceeds a threshold value, the accident type and severity analysis unit determines as minor collision or collision with a soft object.

12. The vehicle accident detection and automatic reporting system according to claim 7, wherein the vehicle terminal further includes:
a microphone which receives surrounding sound signals in the vehicle and
the pre-vehicle collision data includes surrounding sound data received by the microphone during a predetermined time before the collision time and the post-vehicle collision data includes surrounding sound data received by the microphone during a predetermined time after the collision time.
